(19) United States
(12) Patent Application Publication
(10) Pub. No.: US 2024/0232856 A1
(43) Pub. Date: Jul. 11, 2024

(54) PAYMENT METHOD AND APPARATUS, AND DEVICE

(71) Applicant: ALIPAY (HANGZHOU) INFORMATION TECHNOLOGY CO., LTD., Hangzhou, Zhejiang (CN)

(72) Inventors: Yang LI, Hangzhou (CN); Hao CHEN, Hangzhou (CN); Fuyi WANG, Hangzhou (CN); Mengjie ZHOU, Hangzhou (CN); Huifen WANG, Hangzhou (CN)

(21) Appl. No.: 18/560,243

(22) PCT Filed: Apr. 29, 2022
(86) PCT No.: PCT/CN2022/090132

§ 371 Date: Nov. 10, 2023

(30) Foreign Application Priority Data
May 11, 2021 (CN) 202110512497.5

(51) Int. Cl. G06Q 20/34; G06Q 20/32; G06Q 20/38; G06Q 20/40

(52) U.S. Cl. CPC G06Q 20/354; G06Q 20/3255; G06Q 20/389; G06Q 20/4014

(57) ABSTRACT

Embodiments of this specification disclose a payment method, apparatus, and device. The method includes the following: A payment operation performed by a user for a target order by using a target bank card is obtained; status information of a quick payment agreement of the target bank card is obtained; when the status information indicates that the quick payment agreement of the target bank card is in an invalid state, first prompt information for prompting the user to rebind the target bank card is generated; confirmation operation information that is entered by the user based on the first prompt information and that is used to confirm rebinding of the target bank card is received; the target bank card is rebound; and a payment of the target order is completed based on the rebound target bank card.

### TECHNICAL FIELD

This specification relates to the field of computer technologies, and in particular, to a payment method, apparatus, and a device.

### BACKGROUND

In today's rapid development of science and technology, with popularization of e-commerce, a method for making a payment by using a terminal emerges as a new consumption settlement method. In the method for making a payment by using a terminal, a quick payment method has brought great impact on people's life. Under support of powerful network technologies, a quick payment can enable users to make an online purchase, make a transfer, make a living payment, manage finance, and the like without leaving a home. The quick payment is the current most popular consumption method. The development of network technologies promotes popularization of the quick payment method. In a digital era, mobile phones are increasingly functionally powerful, and a mobile payment function of the mobile phone is widely used in various fields of people's life, to provide convenient consumer services for people.

Therefore, a more reliable quick payment method needs to be urgently provided, to improve quick payment experience of a user.

### SUMMARY

Embodiments of this specification provide a payment method, apparatus, and device, to resolve problems of a low payment success rate and poor user payment experience in an existing quick payment method.

To resolve the above-mentioned technical problem, embodiments of this specification are implemented as follows: An embodiment of this specification provides a payment method, including the following: A payment operation performed by a user for a target order by using a target bank card is obtained; status information of a quick payment agreement of the target bank card is obtained; first prompt information is generated when the status information indicates that the quick payment agreement of the target bank card is in an invalid state, where the first prompt information is used to prompt the user to rebind the target bank card; confirmation operation information entered by the user based on the first prompt information is received, where the first confirmation operation information is used to confirm rebinding of the target bank card; the target bank card is rebound based on the first confirmation operation information; and a payment of the target order is completed based on the rebound target bank card.

An embodiment of this specification provides an information display method, including: A terminal obtains a payment operation performed by a user for a target order by using a target bank card; sends the payment operation to a server; obtains first prompt information sent by the server based on the payment operation, where the first prompt information includes at least a payment option, the payment option is used to select a payment method, and the payment option includes an option for rebinding the target bank card; and displays the first prompt information in a payment interface of the target order.

An embodiment of this specification provides a payment apparatus, including: a payment operation obtaining module, configured to obtain a payment operation performed by a user for a target order by using a target bank card; a status information obtaining module, configured to obtain status information of a quick payment agreement of the target bank card; a first prompt information generation module, configured to generate first prompt information when the status information indicates that the quick payment agreement of the target bank card is in an invalid state, where the first prompt information is used to prompt the user to rebind the target bank card; a confirmation operation information receiving module, configured to receive confirmation operation information entered by the user based on the first prompt information, where the first confirmation operation information is used to confirm rebinding of the target bank card; a rebinding module, configured to rebind the target bank card based on the first confirmation operation information; and a payment completion module, configured to complete a payment of the target order based on the rebound target bank card.

An embodiment of this specification provides an information display apparatus, including: a payment operation obtaining module, configured to obtain, by a terminal, a payment operation performed by a user for a target order by using a target bank card; a payment operation sending module, configured to send the payment operation to a server; a first prompt information obtaining module, configured to obtain first prompt information sent by the server based on the payment operation, where the first prompt information includes at least a payment option, the payment option is used to select a payment method, and the payment option includes an option for rebinding the target bank card; and a first prompt information display module, configured to display the first prompt information in a payment interface of the target order.

An embodiment of this specification provides a payment device, including at least one processor and a memory communicatively connected to the at least one processor. The memory stores instructions that can be executed by the at least one processor, and the instructions are executed by the at least one processor, to enable the at least one processor to perform the following operations: obtaining a payment operation performed by a user for a target order by using a target bank card; obtaining status information of a quick payment agreement of the target bank card; generating first prompt information when the status information indicates that the quick payment agreement of the target bank card is in an invalid state, where the first prompt information is used to prompt the user to rebind the target bank card; receiving confirmation operation information entered by the user based on the first prompt information, where the first confirmation operation information is used to confirm rebinding of the target bank card; rebinding the target bank card based on the first confirmation operation information; and completing a payment of the target order based on the rebound target bank card.

An embodiment of this specification provides an information display device, including at least one processor and a memory communicatively connected to the at least one processor. The memory stores instructions that can be executed by the at least one processor, and the instructions are executed by the at least one processor, to enable the at least one processor to perform the following operations: obtaining, by a terminal, a payment operation performed by a user for a target order by using a target bank card; sending the payment operation to a server; obtaining first prompt information sent by the server based on the payment operation, where the first prompt information includes at least a payment option, the payment option is used to select a payment method, and the payment option includes an option for rebinding the target bank card; and displaying the first prompt information in a payment interface of the target order.

An embodiment of this specification provides a computer-readable medium. The computer-readable medium stores computer-readable instructions, and the computer-readable instructions can be executed by a processor to implement the payment method and the display method.

The embodiments of this specification can achieve the following beneficial effects: A payment operation performed by a user for a target order by using a target bank card is obtained; status information of a quick payment agreement of the target bank card is obtained; when the status information indicates that the quick payment agreement of the target bank card is in an invalid state, first prompt information for prompting the user to rebind the target bank card is generated; confirmation operation information that is entered by the user based on the first prompt information and that is used to confirm rebinding of the target bank card is received; the target bank card is rebound; and a payment of the target order is completed based on the rebound target bank card. In a process of making a payment, the user is strongly reminded by using a guidance pop-up window, and a conversion rate of card rebinding is high. In a card binding process, identity information such as a bank card account and a mobile phone number reserved by the user in an Alipay system is directly obtained, the user does not need to re-enter the identity information, a payment is not interrupted after card rebinding is completed, and the payment is directly completed by using the rebound target bank card. In this way, a payment success rate of the user can be increased, and payment experience of the user can be improved.

### BRIEF DESCRIPTION OF DRAWINGS

To describe technical solutions in the embodiments of this specification or in the existing technology more clearly, the following briefly describes the accompanying drawings required for describing the embodiments or the existing technology. Clearly, the accompanying drawings in the following description merely show some embodiments of this specification, and a person of ordinary skill in the art can still derive other drawings from these accompanying drawings without creative efforts.

FIG. 1 is a schematic diagram illustrating a payment failure prompt interface in an existing quick payment method;

FIG. 2 is a schematic flowchart illustrating a payment method, according to an embodiment of this specification;

FIG. 3 is a schematic diagram illustrating interaction in a payment method, according to an embodiment of this specification;

FIG. 4 is a schematic flowchart illustrating an information display method, according to an embodiment of this specification;

FIG. 5 is a schematic diagram illustrating a display interface for rebinding a bank card, according to an embodiment of this specification;

FIG. 6 is a schematic diagram illustrating a structure of a payment apparatus, according to an embodiment of this specification;

FIG. 7 is a schematic diagram illustrating a structure of a display apparatus, according to an embodiment of this specification; and

FIG. 8 is a schematic diagram illustrating a structure of a payment apparatus, according to an embodiment of this specification.

### DESCRIPTION OF EMBODIMENTS

To make the objectives, technical solutions, and advantages of one or more embodiments of this specification clearer, the following clearly and comprehensively describes the technical solutions of the one or more embodiments of this specification with reference to corresponding accompanying drawings and specific embodiments of this specification. Clearly, the described embodiments are merely some but not all of the embodiments of this specification. All other embodiments obtained by a person of ordinary skill in the art based on the embodiments of this specification without creative efforts shall fall within the protection scope of one or more embodiments of this specification.

The terms used in the embodiments of this specification are first explained. A cashier is a mobile carrier provided by a payment application for a user to make a payment. A channel and an amount to be paid by the user can be seen, or a channel can be switched to finally complete a payment.

The technical solutions provided in the embodiments of this specification are described in detail below with reference to the accompanying drawings.

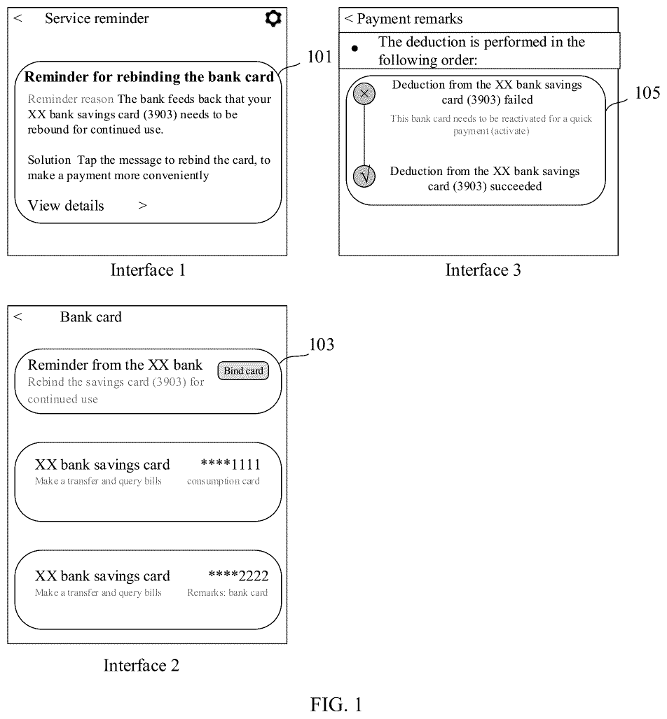

FIG. 1 is a schematic diagram illustrating a payment failure prompt interface in an existing quick payment method.

As shown in FIG. 1, in the existing technology, when a payment on a cashier fails due to invalidity of a quick payment agreement of a bank card, or the like, payment failure information or prompt information for rebinding the card is usually displayed by using the following three methods: Method 1: Prompt information 101 for rebinding the bank card is displayed in a homepage service of a payment application APP. As shown in an interface 1, the prompt information 101 is sent to a user in a service reminder in the payment application APP, to prompt the user to rebind the bank card.

In this method, the displayed prompt information 101 can include reminder information for reminding the user to rebind the bank card, for example, a “reminder for rebinding the bank card”, and can further display information such as a reminder reason and a solution. For example, the reminder reason can be “The bank feeds back that your XX bank savings card (3903) needs to be rebound for continued use”, and the solution can be information such as “Tap the message to rebind the card”. Here. XX can indicate a name of the bank.

Method 2: Card binding reminder information 103 for rebinding the bank card is displayed on a bank card application side. As shown in an interface 2, the card binding reminder information 103 is displayed on the bank card application side. The card binding reminder information can include information about the bank card that needs to be rebound and an option button for selecting “card binding”. For example, the card binding reminder information can be “The savings card (3903) needs to be rebound for continued use”. In addition, the interface 2 can further include information about all bank cards bound in a payment application of a user.

Method 3: Failure information 105 is displayed in a payment bill of a payment application. As shown in an interface 3, the failure information 105 can include deduction failure prompt information and activation information.

In a quick payment process, whether a user has a capability to pay is one of key factors that affect a payment success rate. An excessively large quantity of errors are reported every day for active payment failures caused due to expiration of an agreement of a bank card of the user. Such reported errors usually can be resolved by rebinding the bank card. Previously, for such payment failures, on a cashier, the user is prompted, in a form of text by using the above-mentioned several methods, to rebind the card. In this method, understanding costs are high for the user, a reach rate of the user is low, and a card management function needs to be enabled in an application to rebind the card. Consequently, the procedure is relatively complex, and a conversion rate is low. In addition, when a current payment is completed, the user needs to place a new order and make a payment after binding the card, resulting in a payment loss.

To resolve the disadvantage in the existing technology, this solution provides the following embodiments:

### Embodiment 1

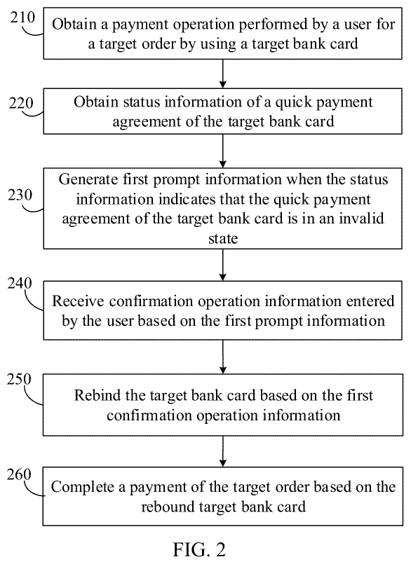

FIG. 2 is a schematic flowchart illustrating a payment method, according to an embodiment of this specification. From a program perspective, the procedure can be performed by a program or an application client that is loaded on an application server. In this embodiment, the procedure can be performed by a server corresponding to an application platform with a payment function, and the server interacts with a user terminal. When detecting a payment failure, the server generates corresponding prompt information, and sends the prompt information to an interface of the user terminal for display, so that a user completes a bank card rebinding operation based on the prompt information.

As shown in FIG. 2, the procedure can include the following steps. Step 210: Obtain a payment operation performed by a user for a target order by using a target bank card.

The target bank card can represent a bank card used to pay for the target order. For example, the user selects, on a shopping platform, a commodity that needs to be purchased, and jumps to a payment application platform to make a payment. When making a payment, the user selects a bank card A to complete a quick payment. In this case, the bank card A can be used as the target bank card.

Step 220: Obtain status information of a quick payment agreement of the target bank card.

The quick payment agreement is an agreement reached between the user and each of a payment application and a bank for a quick payment service. A quick payment means that when the user purchases a commodity, no online banking needs to be activated, and only information such as a bank card number, an account name, and a mobile phone number needs to be provided. After the bank verifies correctness of the mobile phone number, a third-party payment sends a mobile phone dynamic password to the mobile phone number of the user, and the user enters the correct mobile phone dynamic password to complete a payment. If the quick payment agreement is terminated between the user and the payment application or the bank, a payment cannot be made in the payment application by using the bank card.

The status information of the quick payment agreement can indicate an effective status of the quick payment agreement, for example, valid or invalid. The invalid state of the quick payment agreement can be caused due to the following reasons: Reason 1: The user terminates the quick payment agreement between the quick target bank card and the payment application platform on a bank card application side, and therefore the quick payment agreement is invalid. Consequently, the application platform with a payment function cannot complete a quick payment by using the target bank card.

Reason 2: The quick payment agreement of the bank card expires on a cashier of the application platform, and therefore the quick payment agreement is in the invalid state.

Step 230: Generate first prompt information when the status information indicates that the quick payment agreement of the target bank card is in an invalid state, where the first prompt information is used to prompt the user to rebind the target bank card.

When the user makes a payment by using the bank card, if the payment cannot be made by using the bank card of the user due to termination or expiration of the quick payment agreement or the like, this error can be resolved by rebinding the bank card. Therefore, when detecting that a payment failure is caused due to invalidity of the quick payment agreement, the server can generate prompt information to prompt the user to resolve the problem of payment failure by rebinding the bank card.

It should be noted that the first prompt information generated in this solution is displayed in a payment interface. In actual application, in a process in which the user makes a payment by using the target bank card for the target order, when the payment fails, the first prompt information pops up in the payment interface, and the user needs to perform an operation in the payment interface to continue a subsequent operation step.

The first prompt information can include at least option information for selecting another payment method, and can further include option information for “rebinding the card”. That is, when a payment made by using the target bank card fails, the user can select another payment method to make a payment, or can rebind the target bank card, to complete a subsequent payment.

Step 240: Receive confirmation operation information entered by the user based on the first prompt information, where the first confirmation operation information is used to confirm rebinding of the target bank card.

Step 250: Rebind the target bank card based on the first confirmation operation information.

After the user selects to rebind the card, the server receives the confirmation operation information entered by the user, to direct the user to complete a rebinding operation.

Step 260: Complete a payment of the target order based on the rebound target bank card.

The user is directly recommended, by using a pop-up window after a payment failure procedure, to rebind the bank card. Therefore, after the bank card is rebound, the server can automatically invoke the bank card to directly make a payment, and the user does not need to exit the cashier to make a new payment.

It should be understood that in the method described in one or more embodiments of this specification, sequences of some steps in the method can be exchanged with each other based on an actual requirement, or some steps in the method can be omitted or deleted.

In the method in FIG. 2, a payment operation performed by a user for a target order by using a target bank card is obtained; status information of a quick payment agreement of the target bank card is obtained; when the status information indicates that the quick payment agreement of the target bank card is in an invalid state, first prompt information for prompting the user to rebind the target bank card is generated; confirmation operation information that is entered by the user based on the first prompt information and that is used to confirm rebinding of the target bank card is received; the target bank card is rebound; and a payment of the target order is completed based on the rebound target bank card. In a process of making a payment, the user is strongly reminded by using a guidance pop-up window, and a conversion rate of card rebinding is high. In a card binding process, identity information such as a bank card account and a mobile phone number reserved by the user in an Alipay system is directly obtained, the user does not need to re-enter the identity information, a payment is not interrupted after card rebinding is completed, and the payment is directly completed by using the rebound target bank card. In this way, a payment success rate of the user can be increased, and payment experience of the user can be improved.

Based on the method in FIG. 2, an embodiment of this specification further provides some specific implementations of the method, which are described below.

Optionally, before the status information of the quick payment agreement of the target bank card is obtained, the method can further include: obtaining payment failure information corresponding to the target order, where the payment failure information includes at least an error code and application scenario information; and determining an error type corresponding to the payment failure information based on the error code and the application scenario information; and the obtaining status information of a quick payment agreement of the target bank card can specifically include: obtaining the status information of the quick payment agreement of the target bank card when the error type indicates a payment failure caused by the quick payment agreement of the target bank card.

It should be noted that in actual application, a payment failure can correspond to a plurality of error types, for example, an insufficient balance in the target bank card used to make a payment, cancellation of the target bank card, incorrect information about the target bank card, an incorrect password entered by the user, expiration of the quick payment agreement of the bank card, and termination of the quick payment agreement of the bank card.

In this solution, the method steps in this embodiment of this specification are performed only when the quick payment agreement of the target bank card used to pay for the target order is invalid (expires or is terminated). Therefore, after receiving the payment failure information, the server needs to first determine whether the error type of the payment failure satisfies a preset rule, and only when the preset rule is satisfied, a reminder interface pops up in the payment interface.

In an actual operation process, in the payment failure procedure, a downstream system obtains an error code of the payment failure, and determines, by using a rule engine based on dimensions such as the error code of the payment failure and a service scenario, whether to recommend to rebind the bank card. If a recommendation rule is satisfied, the user is recommended, by using a pop-up window after the payment failure procedure, to rebind the bank card. The downstream system can represent a gateway system of a financial network. When a payment is submitted, a payment-related packet is sent to the bank, and the bank returns a processing result. In a normal payment process, if all information is correct, the bank can return payment success information. If the payment fails, the bank returns a corresponding error code.

The error code can be a sequence. Specifically, the error code can be a sequence including letters and numbers, and the error code can correspond to error semantics. For example, an error code A corresponds to invalidity of the quick payment agreement, an error code B corresponds to invalidity of the bank card, and an error code C corresponds to an insufficient balance in the bank card.

When it is determined whether the prompt information can be displayed in the payment interface, determining can be performed with reference to the error code returned by the bank and a specific application scenario.

When detecting that a reason for the payment failure is that the quick payment agreement of the bank card is invalid, the server can generate the first prompt information. The first prompt information can include at least payment failure feedback information, option information of another payment method, and option information for rebinding the card. The payment failure feedback information can be description information of the reason for the payment failure of the target order, for example, can be related information such as “The bank feeds back that the quick payment agreement of the card is invalid, and a payment cannot be made”.

The rebinding the target bank card based on the first confirmation operation information can specifically include: generating, based on the first confirmation operation information, interface guidance information for directing the user to rebind the card, where the interface guidance information includes card information of the target bank card that needs to be rebound, quick payment agreement information, and authorization request information; receiving second confirmation operation information of the user for the authorization request information, where the second confirmation operation information is used to authorize the server to rebind the target bank card; performing identity verification on the user based on the second confirmation operation information; and completing a rebinding operation of the target bank card when the identity verification on the user succeeds.

The first confirmation operation information can indicate an operation of selecting “rebind card” by the user. The interface guidance information can include card number information of the target bank card, for example, last four digits of a bank card number. The quick payment agreement information can be further included. Specifically, the interface guidance information can be a text link of the quick payment agreement information. If the user needs to further view the quick payment agreement information, the user can tap the text link to view the quick payment agreement information. The interface guidance information further includes an agree button provided for the user to perform authorization confirmation. After the user authorizes rebinding of the card, because the server further stores identity information such as a bank card account and a mobile phone number that are reserved by the user in a payment platform system, identity verification can be performed on the user without a need to re-enter related information by the user. After the identity verification on the user succeeds, rebinding of the target bank card is completed.

In the above-mentioned method, it is determined that the payment failure is caused due to invalidity of the quick payment agreement of the bank card. In this case, the prompt information can be displayed in the current payment interface, and the user needs to select any option in the prompt information to continue a subsequent step. If the user selects another payment method, a payment success rate of the user can be increased. A card rebinding component is added to the payment cashier, and the user directly taps a card rebinding option to quickly rebind the target bank card, to increase a rebinding conversion rate of the target bank card and increase a payment success rate of the target bank card.

It should be noted that in this embodiment of this specification, the performing identity verification on the user can be understood as that a verification code is sent to a corresponding mobile phone number, and the user enters the verification code to complete identity verification. However, in a specific implementation process, a mobile phone number reserved by the user in the bank may be changed. To accurately send a subsequent verification code to the corresponding mobile phone number, before identity verification is performed on the user, it can be first determined whether the mobile phone number reserved by the user in the bank is a mobile phone number currently used by the user. Specifically, it can be determined, by using the following steps, whether the current mobile phone number of the user is the mobile phone number reserved in the bank. Optionally, before identity verification is performed on the user based on the second confirmation operation information, the method can further include: receiving a mobile phone number entered by the user; obtaining a pre-stored reserved mobile phone number corresponding to the target bank card from a blockchain system, where the blockchain system stores a mapping relationship between bank card information and a reserved mobile phone number; comparing the mobile phone number entered by the user with the reserved mobile phone number; and performing identity verification on the user when the mobile phone number entered by the user is consistent with the reserved mobile phone number.

Optionally, after the mobile phone number entered by the user is compared with the reserved mobile phone number, the method can further include: generating second prompt information when the mobile phone number entered by the user is inconsistent with the reserved mobile phone number, where the second prompt information is used to request the user to re-enter a mobile phone number; receiving a mobile phone number re-entered by the user, and establishing a new mapping relationship between the re-entered mobile phone number and the target bank card; and uploading the new mapping relationship to the blockchain system for storage.

The rebinding the target bank card based on the first confirmation operation information can specifically include: obtaining user identification information of the user; obtaining bank card information of the target bank card and quick payment agreement information corresponding to the target bank card; generating binding information among the user identification information, the bank card information of the target bank card, and the quick payment agreement; and uploading the binding information to a blockchain system for storage.

In this solution, the mapping relationship between the mobile phone number of the user and the target bank card can be stored in the blockchain system. A blockchain has features of being difficult to be tampered with and deleted. Therefore, after data is stored in the blockchain, the blockchain used as a method for maintaining content integrity is reliable. Therefore, the mapping relationship between the mobile phone number of the user and the target bank card is stored in the blockchain system, to ensure authenticity of the mapping relationship. Further, a correspondence among a user identifier, the target bank card, and the quick payment agreement can also be stored in the blockchain system, to ensure security and credibility of data stored in the blockchain system.

When it is determined whether the mobile phone number of the user is the mobile phone number reserved in the bank, the mobile phone number entered by the user can be compared with the reserved mobile phone number corresponding to the target bank card. If the mobile phone number entered by the user is consistent with the reserved mobile phone number corresponding to the target bank card, verification code information is directly sent. If the mobile phone number entered by the user is inconsistent with the reserved mobile phone number corresponding to the target bank card, the user is requested to re-enter a new mobile phone number, and then a verification code is sent to the new mobile phone number for verification.

In a specific verification process, the following steps can be included. The performing identity verification on the user can specifically include: sending an SMS message to the mobile phone number entered by the user, where the SMS message includes a check code; receiving a check code entered by the user; comparing whether the check code entered by the user is consistent with the check code included in the SMS message; and determining, when the check code entered by the user is consistent with the check code included in the SMS message, that the identity verification on the user succeeds.

In the above-mentioned method, it can be ensured that the verification code can be sent to an accurate and valid mobile phone number, to improve efficiency of performing identity verification on the user, and further improve payment efficiency of the target bank card.

Optionally, the completing a payment of the target order based on the rebound target bank card can specifically include: determining status information of a quick payment agreement corresponding to the rebound target bank card, where the status information is used to indicate an effective status of the quick payment agreement of the rebound target bank card; and completing the payment of the target order based on the rebound target bank card when the status information indicates that the quick payment agreement of the rebound target bank card is valid.

Optionally, after the status information of the quick payment agreement corresponding to the rebound target bank card is determined, the method can further include: uploading the status information of the quick payment agreement corresponding to the rebound target bank card to a blockchain system for storage when the status information indicates that the quick payment agreement of the rebound target bank card is valid.

The blockchain system can further store the status information of the quick payment agreement of the target bank card. When the status information is changed, the status information of the quick payment agreement stored in the blockchain system is correspondingly updated.

The rebinding the target bank card can be understood as resigning or activating the quick payment agreement corresponding to the target bank card. For the rebound target bank card, the quick payment agreement corresponding to the rebound target bank card should be in an effective state. The target bank card can be used to pay for the target order only when the quick payment agreement is in the effective state.

In the above-mentioned method, the rebound target bank card is used to directly pay for the target order. The bank card rebinding component is built into the cashier. In a payment process, the target bank card is rebound without interrupting a transaction, and the payment can be directly completed, to increase a payment success rate of the bank card.

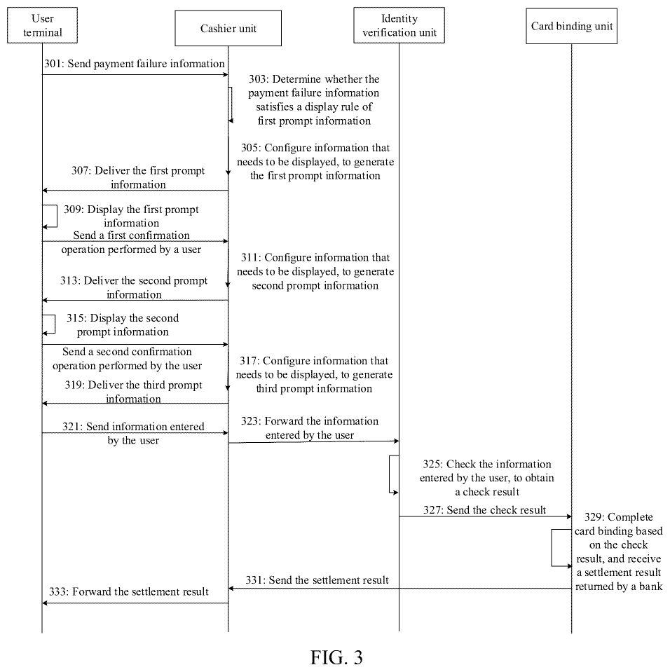

The method in Embodiment 1 relates to an interaction relationship between the user terminal and some modules in the payment application platform. Implementation of an entire procedure can be described with reference to FIG. 3. FIG. 3 is a schematic diagram illustrating interaction in a payment method, according to an embodiment of this specification. As shown in FIG. 3, involved interaction subjects can include a user terminal, a cashier unit, an identity verification unit, and a card binding unit. The cashier unit can be configured to render and display a page, and can be further configured to manage a lifecycle of an asset, and the like. The card binding unit can interact with the bank, and convert information returned by the bank into an error code. Specifically, the following procedure steps can be included. Step 301: The cashier unit receives payment failure information of the user.

Step 303: The cashier unit determines whether the payment failure information satisfies a display rule of first prompt information.

Step 305: When the payment failure information satisfies the display rule of the first prompt information, the cashier unit configures information that needs to be displayed, to generate the first prompt information.

Step 307: The cashier unit delivers the generated first prompt information to the user terminal.

Step 309: The user terminal displays the first prompt information.

Step 311: The cashier unit receives a first confirmation operation sent by the user terminal, and configures information that needs to be displayed, to generate second prompt information.

Step 313: Send the second prompt information to the user terminal.

Step 315: The user terminal displays the second prompt information, to direct the user to confirm authorization to rebind the card.

Step 317: The cashier unit receives a second confirmation operation performed by the user, and configures information that needs to be displayed, to generate third prompt information.

Step 319: Send the third prompt information to the user terminal for display.

Step 321: Receive information entered by the user.

Step 323: Send the information entered by the user to the identity verification unit.

Step 325: The identity verification unit checks the information entered by the user, to obtain a check result.

Step 327: Send the check result to the card binding unit after the check succeeds.

Step 329: The card binding unit rebinds the card based on the check result, sends a settlement request to a bank based on the rebound bank card, and receives a settlement result returned by the bank.

Step 331: Send the settlement result to the cashier unit.

Step 333: The cashier unit sends the settlement result to the user terminal for display.

### Embodiment 2

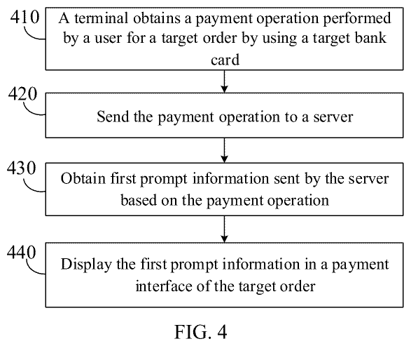

FIG. 4 is a schematic flowchart illustrating an information display method, according to an embodiment of this specification. From a program perspective, the procedure can be performed by a program or an application client that is loaded on an application server. In this embodiment, the procedure can be performed by a user terminal, an application with a payment function is installed in the user terminal, and a server of the application interacts with the user terminal. When detecting a payment failure, the server generates corresponding prompt information, and sends the prompt information to an interface of the user terminal for display, so that a user completes a bank card rebinding operation based on the prompt information.

As shown in FIG. 4, the procedure can include the following steps. Step 410: The terminal obtains a payment operation performed by a user for a target order by using a target bank card.

Step 420: Send the payment operation to the server.

It should be noted that the terminal can directly obtain the payment operation performed by the user for the target order in an interface of the terminal. The payment operation that is performed by the user and that is obtained from the server can be forwarded by the user terminal to the server.

Step 430: Obtain first prompt information sent by the server based on the payment operation, where the first prompt information includes at least a payment option, the payment option is used to select a payment method, and the payment option includes an option for rebinding the target bank card.

The payment option in the above-mentioned step can provide a plurality of payment methods for the user. If the user still wants to use the target bank card to make a payment, the user can tap the card rebinding option in the payment option to rebind the target bank card.

Step 440: Display the first prompt information in a payment interface of the target order.

It should be noted that the first prompt information needs to be displayed in the payment interface of the target order, so that the user can more clearly see rebinding information of the target bank card in a payment process, to increase a reach rate of the user.

Some content in this embodiment is the same as that in Embodiment 1. For related descriptions of the same part, references can be made to Embodiment 1. Details are not described in this embodiment.

In the method in FIG. 4, the terminal obtains a payment operation performed by a user for a target order by using a target bank card; sends the payment operation to the server; obtains first prompt information that is sent by the server based on the payment operation and that includes a card rebinding option; and displays the first prompt information in a payment interface of the target order. In a process of making a payment for the target order, the prompt information is displayed, to strongly remind the user to pay attention to card rebinding information, increase a reach rate of the user, and further increase a conversion rate of card rebinding.

Based on the method in FIG. 4, an embodiment of this specification further provides some specific implementations of the method, which are described below.

Optionally, after the first prompt information is displayed in the payment interface of the target order, the method can further include: receiving confirmation operation information entered by the user in the payment interface based on the first prompt information; sending the confirmation operation information to the server; receiving feedback information obtained after the server rebinds the target bank card based on the confirmation operation information, where the feedback information indicates that the target bank card is successfully rebound; and displaying the feedback information in an interface of the terminal.

Optionally, after the confirmation operation information entered by the user in the payment interface based on the first prompt information, the method can further include: receiving second prompt information generated by the server based on the confirmation operation information, where the second prompt information is used to confirm rebinding of the target bank card; displaying the second prompt information in the interface of the terminal; receiving confirmation operation information entered by the user in the interface of the terminal based on the second prompt information; and sending the confirmation operation information entered based on the second prompt information to the server.

Optionally, after the confirmation operation information entered based on the second prompt information is sent to the server, the method can further include: receiving third prompt information generated by the server, where the third prompt information is used to prompt the user to re-enter a mobile phone number.

Optionally, after the third prompt information generated by the server is received, the method can further include: receiving fourth prompt information generated by the server based on the mobile phone number re-entered by the user, where the fourth prompt information is used to prompt the user to enter a verification code sent to the re-entered mobile phone number; and displaying the fourth prompt information in the interface of the terminal.

Optionally, after the confirmation operation information entered based on the second prompt information is sent to the server, the method can further include: receiving fifth prompt information generated by the server, where the fifth prompt information is used to prompt the user to enter a verification code sent to a reserved mobile phone number of the target bank card; and displaying the fifth prompt information in the interface of the terminal.

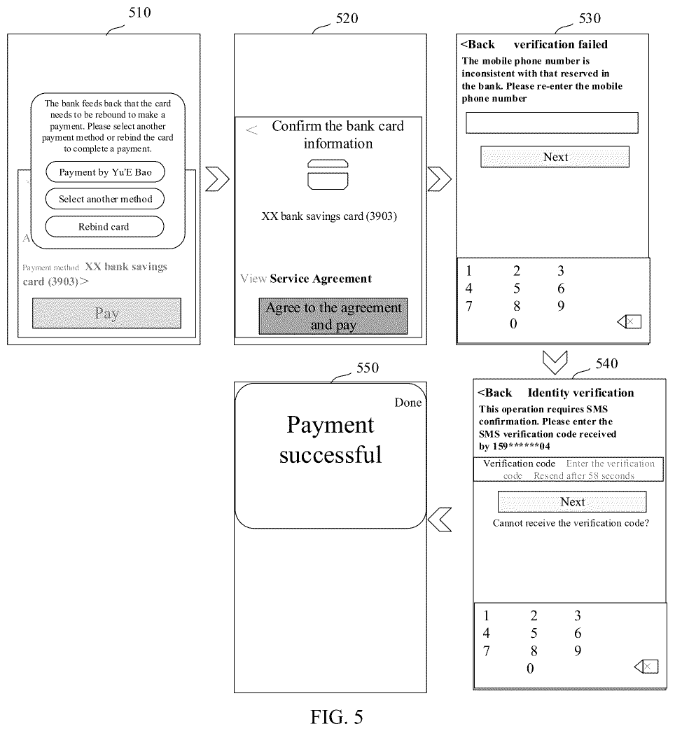

The above-mentioned procedure of displaying corresponding prompt information in the terminal, to prompt the user to complete a rebinding operation can be described with reference to FIG. 5. FIG. 5 is a schematic diagram illustrating a display interface for rebinding a bank card, according to an embodiment of this specification.

As shown in FIG. 5, there are five display interfaces: a cashier error reporting interface 510, a rebinding prompt interface 520, a mobile phone number input interface 530, an identity verification interface 540, and a payment result display interface 550. When the server detects that an error type of the payment failure is invalidity of a quick payment agreement of the target bank card, the first prompt information is displayed in the cashier error reporting interface 510. The first prompt information includes payment failure feedback information, payment method option information, and option information for rebinding the card. For example, the payment failure feedback information can be “The bank feeds back that the card needs to be rebound to make a payment. Please select another payment method or rebind the card to complete a payment”. It should be noted that the first prompt information is displayed in the payment interface of the target order. After the user taps the “rebind card” option, the rebinding prompt interface 520 is displayed, and the second prompt information is displayed in the rebinding prompt interface 520. The second prompt information can include information about the target bank card that needs to be rebound, service agreement option information, and rebinding confirmation information. The information about the target bank card that needs to be rebound can include information about a bank to which the bank card belongs, last four digits of a bank card number, and other information. The rebinding confirmation information can be option information “agree to the agreement and pay” in the rebinding prompt interface 520. When the user taps a “service agreement” button, specific service agreement content can be viewed. When the user taps an “agree to the agreement and pay” option, the mobile phone number input interface 530 can be displayed in the interface of the user terminal. In the interface, the user is prompted to enter a mobile phone number. When the mobile phone number entered by the user is consistent with that reserved in the bank, a verification code is directly sent to the mobile phone number, and the identity verification interface 540 is displayed, to prompt the user to enter the verification code. However, if the mobile phone number entered by the user is inconsistent with that reserved in the bank, the server displays, in the mobile phone number input interface 530, information for prompting the user to re-enter a mobile phone number. For example, related information “The mobile phone number is inconsistent with that reserved in the bank. Please re-enter the mobile phone number” is displayed, to request the user to re-enter the mobile phone number. In the identity verification interface 540, the user enters the corresponding verification code. When verification code information is correctly entered, a payment is completed, and the payment result display interface 550 is displayed. Related prompt information indicating that the payment succeeds is displayed in the interface.

It should be noted that the information displayed in the five display interfaces can be configured in a configurable manner to display guidance text. Configuration information in the display interface can be modified based on an actual card binding rate of the user and a payment success rate that are subsequently counted, to modify displayed text information in each display page, so as to bring better user experience to the user and increase a card binding conversion rate of the user.

The above-mentioned display method supports customized admission rules for payment scenarios and payment error codes. After a rule is satisfied, a pop-up window recommendation method is used in a process of making a payment, to direct a user to enter a bank card rebinding procedure, and a conversion rate of carding rebinding is high. Identity information such as a bank card account and a mobile number reserved by the user in an Alipay system is directly obtained, and the user does not need to re-enter the identity information. A payment is not interrupted, and after the user rebinds a card, the payment is directly made by using the card. In a cashier payment procedure, rebinding guidance page of the bank card is designed and supports configuration, and therefore strong scalability is achieved.

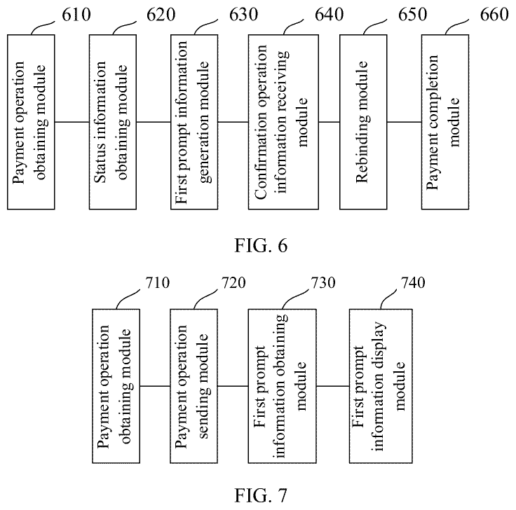

Based on the same idea, an embodiment of this specification further provides an apparatus corresponding to the method in Embodiment 1. FIG. 6 is a schematic diagram illustrating a structure of a payment apparatus, according to an embodiment of this specification. As shown in FIG. 6, the apparatus can include: a payment operation obtaining module 610, configured to obtain a payment operation performed by a user for a target order by using a target bank card; a status information obtaining module 620, configured to obtain status information of a quick payment agreement of the target bank card; a first prompt information generation module 630, configured to generate first prompt information when the status information indicates that the quick payment agreement of the target bank card is in an invalid state, where the first prompt information is used to prompt the user to rebind the target bank card; a confirmation operation information receiving module 640, configured to receive confirmation operation information entered by the user based on the first prompt information, where the first confirmation operation information is used to confirm rebinding of the target bank card; a rebinding module 650, configured to rebind the target bank card based on the first confirmation operation information; and a payment completion module 660, configured to complete a payment of the target order based on the rebound target bank card.

Based on the apparatus in FIG. 6, an embodiment of this specification further provides some specific implementations of the method, which are described below.

The apparatus can further include: a payment failure information obtaining unit, configured to obtain payment failure information corresponding to the target order, where the payment failure information includes at least an error code and application scenario information; and an error type determining unit, configured to determine an error type corresponding to the payment failure information based on the error code and the application scenario information. The status information obtaining module 620 can specifically include a status information obtaining unit, configured to obtain the status information of the quick payment agreement of the target bank card when the error type indicates a payment failure caused by the quick payment agreement of the target bank card.

Optionally, the first prompt information can include at least payment failure feedback information, option information of another payment method, and option information for rebinding the card.

Optionally, the rebinding module 650 can specifically include: an interface guidance information generation unit, configured to generate, based on the first confirmation operation information, interface guidance information for directing the user to rebind the card, where the interface guidance information includes card information of the target bank card that needs to be rebound, quick payment agreement information, and authorization request information; a second confirmation operation information receiving unit, configured to receive second confirmation operation information of the user for the authorization request information, where the second confirmation operation information is used to authorize a server to rebind the target bank card; an identity verification unit, configured to perform identity verification on the user based on the second confirmation operation information; and a card binding completion unit, configured to complete a rebinding operation of the target bank card when the identity verification on the user succeeds.

Optionally, the identity verification unit can be further configured to receive a mobile phone number entered by the user; obtain a pre-stored reserved mobile phone number corresponding to the target bank card from a blockchain system, where the blockchain system stores a mapping relationship between bank card information and a reserved mobile phone number; compare the mobile phone number entered by the user with the reserved mobile phone number; and perform identity verification on the user when the mobile phone number entered by the user is consistent with the reserved mobile phone number.

Optionally, the identity verification unit can be further configured to generate second prompt information when the mobile phone number entered by the user is inconsistent with the reserved mobile phone number, where the second prompt information is used to request the user to re-enter a mobile phone number; receive a mobile phone number re-entered by the user, and establish a new mapping relationship between the re-entered mobile phone number and the target bank card; and upload the new mapping relationship to the blockchain system for storage.

Optionally, the identity verification unit can be specifically configured to send an SMS message to the mobile phone number entered by the user, where the SMS message includes a check code; receive a check code entered by the user; compare whether the check code entered by the user is consistent with the check code included in the SMS message; and determine, when the check code entered by the user is consistent with the check code included in the SMS message, that the identity verification on the user succeeds.

Optionally, the rebinding module 650 can specifically include: a user identification information obtaining unit, configured to obtain user identification information of the user; a quick payment agreement information obtaining unit, configured to obtain bank card information of the target bank card and quick payment agreement information corresponding to the target bank card; a binding information generation unit, configured to generate binding information among the user identification information, the bank card information of the target bank card, and the quick payment agreement, and a storage unit, configured to upload the binding information to a blockchain system for storage.

Optionally, the payment completion module 660 can specifically include: a status information determining unit, configured to determine status information of a quick payment agreement corresponding to the rebound target bank card, where the status information is used to indicate an effective status of the quick payment agreement of the rebound target bank card; and a payment completion unit, configured to complete the payment of the target order based on the rebound target bank card when the status information indicates that the quick payment agreement of the rebound target bank card is valid.

Optionally, the status information determining unit can be further configured to upload the status information of the quick payment agreement corresponding to the rebound target bank card to a blockchain system for storage when the status information indicates that the quick payment agreement of the rebound target bank card is valid.

Based on the same idea, an embodiment of this specification further provides an apparatus corresponding to the method in Embodiment 2. FIG. 7 is a schematic diagram illustrating a structure of a display apparatus, according to an embodiment of this specification. As shown in FIG. 7, the apparatus can include: a payment operation obtaining module 710, configured to obtain, by a terminal, a payment operation performed by a user for a target order by using a target bank card; a payment operation sending module 720, configured to send the payment operation to a server; a first prompt information obtaining module 730, configured to obtain first prompt information sent by the server based on the payment operation, where the first prompt information includes at least a payment option, the payment option is used to select a payment method, and the payment option includes an option for rebinding the target bank card; and a first prompt information display module 740, configured to display the first prompt information in a payment interface of the target order.

Based on the apparatus in FIG. 7, an embodiment of this specification further provides some specific implementations of the method, which are described below.

Optionally, the apparatus can further include: a confirmation operation information receiving module, configured to receive confirmation operation information entered by the user in the payment interface based on the first prompt information; a confirmation operation information sending module, configured to send the confirmation operation information to the server; a feedback information receiving module, configured to receive feedback information obtained after the server rebinds the target bank card based on the confirmation operation information, where the feedback information indicates that the target bank card is successfully rebound; and a feedback information display module, configured to display the feedback information in an interface of the terminal.

Optionally, the apparatus can be further configured to receive second prompt information generated by the server based on the confirmation operation information, where the second prompt information is used to confirm rebinding of the target bank card; display the second prompt information in the interface of the terminal; receive confirmation operation information entered by the user in the interface of the terminal based on the second prompt information; and send the confirmation operation information entered based on the second prompt information to the server.

Optionally, the apparatus can be further configured to receive third prompt information generated by the server, where the third prompt information is used to prompt the user to re-enter a mobile phone number.

Optionally, the apparatus can be further configured to receive fourth prompt information generated by the server based on the mobile phone number re-entered by the user, where the fourth prompt information is used to prompt the user to enter a verification code sent to the re-entered mobile phone number; and display the fourth prompt information in the interface of the terminal.

Optionally, the apparatus can be further configured to receive fifth prompt information generated by the server, where the fifth prompt information is used to prompt the user to enter a verification code sent to a reserved mobile phone number of the target bank card; and display the fifth prompt information in the interface of the terminal.

Based on the same idea, an embodiment of this specification further provides a device corresponding to the above-mentioned method.

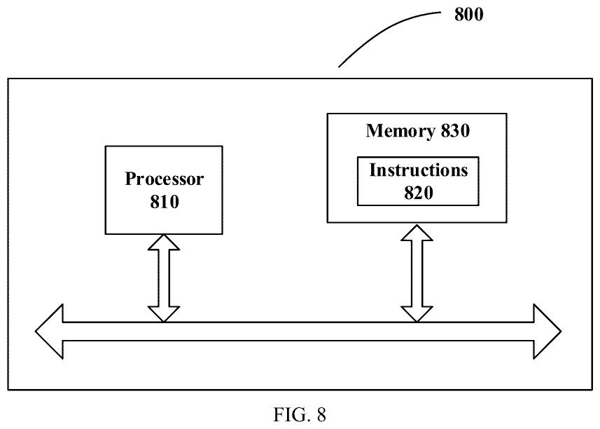

FIG. 8 is a schematic diagram illustrating a structure of a payment apparatus, according to an embodiment of this specification. As shown in FIG. 8, the device 800 can include at least one processor 810 and a memory 830 communicatively connected to the at least one processor. The memory 830 stores instructions 820 that can be executed by the at least one processor 810.

Corresponding to Embodiment 1, the instructions are executed by the at least one processor 810, to enable the at least one processor 810 to perform the following operations: obtaining a payment operation performed by a user for a target order by using a target bank card; obtaining status information of a quick payment agreement of the target bank card; generating first prompt information when the status information indicates that the quick payment agreement of the target bank card is in an invalid state, where the first prompt information is used to prompt the user to rebind the target bank card; receiving confirmation operation information entered by the user based on the first prompt information, where the first confirmation operation information is used to confirm rebinding of the target bank card; rebinding the target bank card based on the first confirmation operation information; and completing a payment of the target order based on the rebound target bank card.

Corresponding to Embodiment 2, the instructions are executed by the at least one processor 810, to enable the at least one processor 810 to perform the following operations: obtaining, by a terminal, a payment operation performed by a user for a target order by using a target bank card; sending the payment operation to a server; obtaining first prompt information sent by the server based on the payment operation, where the first prompt information includes at least a payment option, the payment option is used to select a payment method, and the payment option includes an option for rebinding the target bank card; and displaying the first prompt information in a payment interface of the target order.

Based on the same idea, an embodiment of this specification further provides a computer-readable medium corresponding to the above-mentioned method. The computer-readable medium stores computer-readable instructions.

Corresponding to Embodiment 1, the computer-readable instructions can be executed by a processor to implement the following method: obtaining a payment operation performed by a user for a target order by using a target bank card; obtaining status information of a quick payment agreement of the target bank card; generating first prompt information when the status information indicates that the quick payment agreement of the target bank card is in an invalid state, where the first prompt information is used to prompt the user to rebind the target bank card; receiving confirmation operation information entered by the user based on the first prompt information, where the first confirmation operation information is used to confirm rebinding of the target bank card; rebinding the target bank card based on the first confirmation operation information; and completing a payment of the target order based on the rebound target bank card.

Corresponding to Embodiment 2, the computer-readable instructions can be executed by a processor to implement the following method: obtaining, by a terminal, a payment operation performed by a user for a target order by using a target bank card; sending the payment operation to a server; obtaining first prompt information sent by the server based on the payment operation, where the first prompt information includes at least a payment option, the payment option is used to select a payment method, and the payment option includes an option for rebinding the target bank card; and displaying the first prompt information in a payment interface of the target order.

The embodiments of this specification are described in a progressive way. For same or similar parts of the embodiments, mutual references can be made to the embodiments. Each embodiment focuses on a difference from other embodiments. Particularly, the device embodiments are basically similar to the method embodiments, and therefore are described briefly. For related parts, references can be made to some descriptions in the method embodiments.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers obtain a corresponding hardware circuit structure by programming an improved method procedure into a hardware circuit. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). At present, the Very-High-Speed Integrated Circuit Hardware Description Language (VHDL) and Verilog are most commonly used. It should also be clear to a person skilled in the art that a hardware circuit for implementing a logical method procedure can be easily obtained by performing slight logic programming on the method procedure by using the above-mentioned several hardware description languages and programming the method procedure into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that in addition to implementing the controller by using only the computer-readable program code, logic programming can be performed on method steps to enable the controller to implement the same function in forms of the logic gate, the switch, the application-specific integrated circuit, the programmable logic controller, the built-in microcontroller, and the like. Therefore, the controller can be considered as a hardware component, and an apparatus configured to implement various functions in the controller can also be considered as a structure in the hardware component. Alternatively, the apparatus configured to implement various functions can even be considered as both a software module implementing the method and a structure in the hardware component.

The system, apparatus, module, or unit illustrated in the above-mentioned embodiments can be specifically implemented by using a computer chip or an entity, or can be implemented by using a product having a specific function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, when this specification is implemented, functions of the units can be implemented in one or more pieces of software and/or hardware. A person skilled in the art should understand that an embodiment of this specification can be provided as a method, a system, or a computer program product. Therefore, this specification can use a form of hardware only embodiments, software only embodiments, or embodiments with a combination of software and hardware. Moreover, this specification can use a form of a computer program product that is implemented on one or more computer-usable storage media (including but not limited to a disk memory, a CD-ROM, an optical memory, and the like) that include computer-usable program code.

This specification is described with reference to the flowcharts and/or block diagrams of the method, the device (system), and the computer program product based on the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more procedures in the flowcharts and/or in one or more blocks in the block diagrams.

Alternatively, these computer program instructions can be stored in a computer-readable memory that can instruct a computer or another programmable data processing device to work in a specific way, so the instructions stored in the computer-readable memory generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more memories. The memory can include a form of a volatile memory, a random access memory (RAM), a nonvolatile memory, and/or the like in a computer readable medium, such as a read-only memory (ROM) or a flash memory (flash RAM). The memory is an example of the computer-readable medium. The computer-readable medium includes persistent, non-persistent, removable and non-removable media that can store information by using any method or technology. The information can be computer-readable instructions, a data structure, a program module, or other data. Examples of a computer storage medium include but are not limited to a phase change memory (PRAM), a static random access memory (SRAM), a dynamic random access memory (DRAM) or another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a magnetic cassette, a magnetic tape, a magnetic tape/magnetic disk memory or another magnetic storage device, or any other non-transmission medium that can be used to store information that can be accessed by a computing device. Based on the definition in this specification, the computer-readable medium does not include a transitory computer-readable medium, for example, a modulated data signal and carrier.

It should be further noted that the terms “include”, “comprise”, or any other variant thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product, or device that includes the element.

A person skilled in the art should understand that an embodiment of this specification can be provided as a method, a system, or a computer program product. Therefore, this specification can use a form of hardware only embodiments, software only embodiments, or embodiments with a combination of software and hardware. Moreover, this specification can use a form of a computer program product that is implemented on one or more computer-usable storage media (including but not limited to a disk memory, a CD-ROM, an optical memory, and the like) that include computer-usable program code.

This specification can be described in the general context of computer-executable instructions, for example, a program module. Generally, the program module includes a routine, a program, an object, a component, a data structure, and the like for executing a specific task or implementing a specific abstract data type. This specification can alternatively be practiced in distributed computing environments in which tasks are performed by remote processing devices that are connected through a communication network. In the distributed computing environments, the program module can be located in a local and remote computer storage medium including a storage device.

The above-mentioned descriptions are merely embodiments of this specification, and are not intended to limit this specification. A person skilled in the art can make various modifications and changes to this specification. Any modification, equivalent replacement, or improvement made without departing from the spirit and principle of this specification shall fall within the scope of the claims in this specification.

1. A payment method, comprising:
obtaining a payment operation performed by a user for a target order by using a target bank card;
obtaining status information of a quick payment agreement of the target bank card;
generating first prompt information when the status information indicates that the quick payment agreement of the target bank card is in an invalid state, wherein the first prompt information is used to prompt the user to rebind the target bank card;
receiving confirmation operation information entered by the user based on the first prompt information, wherein the first confirmation operation information is used to confirm rebinding of the target bank card;
rebinding the target bank card based on the first confirmation operation information; and
completing a payment of the target order based on the rebound target bank card.

2. The method according to claim 1, before the obtaining status information of a quick payment agreement of the target bank card, further comprising:
obtaining payment failure information corresponding to the target order, wherein the payment failure information comprises at least an error code and application scenario information; and
determining an error type corresponding to the payment failure information based on the error code and the application scenario information; and
the obtaining status information of a quick payment agreement of the target bank card specifically comprises:
obtaining the status information of the quick payment agreement of the target bank card when the error type indicates a payment failure caused by the quick payment agreement of the target bank card.

3. The method according to claim 1, wherein the first prompt information comprises at least payment failure feedback information, option information of another payment method, and option information for rebinding the card.

4. The method according to claim 3, wherein the rebinding the target bank card based on the first confirmation operation information specifically comprises:
generating, based on the first confirmation operation information, interface guidance information for directing the user to rebind the card, wherein the interface guidance information comprises card information of the target bank card that needs to be rebound, quick payment agreement information, and authorization request information;
receiving second confirmation operation information of the user for the authorization request information, wherein the second confirmation operation information is used to authorize a server to rebind the target bank card;
performing identity verification on the user based on the second confirmation operation information; and
completing a rebinding operation of the target bank card when the identity verification on the user succeeds.

5. The method according to claim 4, before the performing identity verification on the user based on the second confirmation operation information, further comprising:
receiving a mobile phone number entered by the user;
obtaining a pre-stored reserved mobile phone number corresponding to the target bank card from a blockchain system, wherein the blockchain system stores a mapping relationship between bank card information and a reserved mobile phone number;
comparing the mobile phone number entered by the user with the reserved mobile phone number; and
performing identity verification on the user when the mobile phone number entered by the user is consistent with the reserved mobile phone number.

6. The method according to claim 5, after the comparing the mobile phone number entered by the user with the reserved mobile phone number, further comprising:
generating second prompt information when the mobile phone number entered by the user is inconsistent with the reserved mobile phone number, wherein the second prompt information is used to request the user to re-enter a mobile phone number;
receiving a mobile phone number re-entered by the user, and establishing a new mapping relationship between the re-entered mobile phone number and the target bank card; and
uploading the new mapping relationship to the blockchain system for storage.

7. The method according to claim 5, wherein the performing identity verification on the user specifically comprises:
sending an SMS message to the mobile phone number entered by the user, wherein the SMS message comprises a check code;
receiving a check code entered by the user;
comparing whether the check code entered by the user is consistent with the check code comprised in the SMS message; and
determining, when the check code entered by the user is consistent with the check code comprised in the SMS message, that the identity verification on the user succeeds.

8. The method according to claim 1, wherein the rebinding the target bank card based on the first confirmation operation information specifically comprises:
obtaining user identification information of the user;
obtaining bank card information of the target bank card and quick payment agreement information corresponding to the target bank card;
generating binding information among the user identification information, the bank card information of the target bank card, and the quick payment agreement; and
uploading the binding information to a blockchain system for storage.

9. The method according to claim 1, wherein the completing a payment of the target order based on the rebound target bank card specifically comprises:
determining status information of a quick payment agreement corresponding to the rebound target bank card, wherein the status information is used to indicate an effective status of the quick payment agreement of the rebound target bank card; and
completing the payment of the target order based on the rebound target bank card when the status information indicates that the quick payment agreement of the rebound target bank card is valid.

10. The method according to claim 9, after the determining status information of a quick payment agreement corresponding to the rebound target bank card, further comprising:
uploading the status information of the quick payment agreement corresponding to the rebound target bank card to a blockchain system for storage when the status information indicates that the quick payment agreement of the rebound target bank card is valid.

11. (canceled)

12. (canceled)

13. (canceled)

14. (canceled)

15. (canceled)

16. (canceled)

17. (canceled)

18. (canceled)

19. A payment device, comprising: a memory and a processor, wherein the memory stores executable instructions that, in response to execution by the processor, cause the processor to:
obtain a payment operation performed by a user for a target order by using a target bank card;
obtain status information of a quick payment agreement of the target bank card;
generate first prompt information when the status information indicates that the quick payment agreement of the target bank card is in an invalid state, wherein the first prompt information is used to prompt the user to rebind the target bank card;
receive confirmation operation information entered by the user based on the first prompt information, wherein the first confirmation operation information is used to confirm rebinding of the target bank card;
rebind the target bank card based on the first confirmation operation information; and
complete a payment of the target order based on the rebound target bank card.

20. (canceled)

21. A non-transitory computer-readable storage medium comprising instructions stored therein that, when executed by a processor of a computing device, cause the processor to:
obtain a payment operation performed by a user for a target order by using a target bank card;
obtain status information of a quick payment agreement of the target bank card;
generate first prompt information when the status information indicates that the quick payment agreement of the target bank card is in an invalid state, wherein the first prompt information is used to prompt the user to rebind the target bank card;
receive confirmation operation information entered by the user based on the first prompt information, wherein the first confirmation operation information is used to confirm rebinding of the target bank card;
rebind the target bank card based on the first confirmation operation information; and
complete a payment of the target order based on the rebound target bank card.
